(19) United States
(12) Patent Application Publication
(10) Pub. No.: US 2006/0246970 A1
(43) Pub. Date: Nov. 2, 2006

(54) Immersive alternate reality game

(76) Inventors: Michael Acton Smith, Marlow (GB); Adrian Hon, West Kirby (GB); Daniel Hon, West Kirby (GB)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/414,673

(22) Filed: Apr. 28, 2006

Related U.S. Application Data
(60) Provisional application No. 60/675,666, filed on Apr. 28, 2005.

(51) Int. Cl. A63F 13/00

(52) U.S. Cl. 463/1; 463/43

(57) ABSTRACT

An architecture for an alternative reality game that provides a revenue stream to a game provider. A game objective and a narrative are defined as is a set of collectible game pieces. The collectible game piece comprises a unique identifier and a narrative element. The narrative element of at least some of the collectible game pieces relates to the narrative. A puzzle and a puzzle solution are assigned to the collectible game piece and the puzzle and the puzzle solution are associated with the unique identifier. The puzzle solution of at least some of the collectible game pieces relates to achievement of the game objective. A player purchases a random assortment of collectible game pieces and proffers proffers the unique identifier and a proffered puzzle solution to a game provider server. If the proffered solution is the puzzle solution, the game player is awarded points. A prize is offered to a winning player achieving the game objective and having the most points.

### CROSS REFERENCE TO RELATED APPLICATIONS

This application claims the benefit under 35 U.S.C. § 119(e) of provisional application No. 60/675,666 filed Apr. 28, 2005. The 60/675,666 provisional application is incorporated by reference herein, in its entirety, for all purposes.

### BACKGROUND

Embodiments of the present invention relate generally to reality games and more particularly to methods for funding an immersive alternate reality game, and to the rules involved in the production and playing of an immersive alternate reality game.

An alternate reality game (ARG) is a cross-media game that deliberately blurs the line between the in-game and out-of-game experiences. While games may primarily be centered around online resources, events that happen inside the game reality, according to its plotline, will often “reach out” into the players' lives in order to bring them together. Elements of the plotline may be provided to the players in almost any form. Some examples of the forms used to provide plotline elements are:
e-mail
websites, both those obviously connected with the game and those innocent looking—often where the bulk of the game lies, these sites provide puzzles in many forms, e.g. cryptography
phone calls to a player's home, cell or work phone
land mail
newspaper articles or classifieds
chat/Instant messaging and so on—the games have been known to initiate conversation
IRC channels
real world artifacts related to the game in play
real world events utilizing actors who interact with the players who attend

These games often have a specific goal of not only involving the player with the story and/or fictional characters but of connecting them to each other. Many game puzzles can be solved only by the collective and collaborative efforts of multiple players. The players, however, may be driven by conflicting motivations and thus may not always be trustworthy.

The first mainstream “alternate reality game” (known as the “Beast”) was released by Microsoft as an online and off-line (real world) advertising promotion for the Warner Brothers/Dreamworks SKG film “A.I. Artificial Intelligence” (“A.I.”) released in 2001. The game involved the use of thousands of players dispersed worldwide who communicated with each other through player-built and player-maintained resources.

The Beast relied on a published “narrative” that was dispersed over many media (including websites, faxes, e-mails, telephone voicemail boxes, newspaper advertisements and live ‘events’) where actors and actresses would interact with players. The narrative was published in a “soap opera” format in that additional portions of narrative were revealed to players on a weekly basis. Other portions of the narrative were revealed to the players upon the accomplishment of certain tasks or the solving of certain puzzles.

While the Beast provided promotional benefits for the AI movie and was popular among its participants, the game did not produce a revenue stream for Microsoft. The narrative for the Beast was provided to the players free of charge to participants.

The ARG “Majestic” was released by Electronic Arts in July of 2001 was billed by Electronic Arts as “the first online entertainment experience.” Its press release described it as “a blend of storytelling, gameplay and communications” blurring “the line between fact and fiction to create a more compelling and engaging experience that unfolds at an unpredictable, real-time, real world pace.”

Majestic was provided on a subscription basis. Players would buy an off-the shelf boxed product containing installation CD. The implementation relied on custom client-server software produced by Electronic Arts, the client side portion of which required explicit installation on a player's computer. Continuing participation required payment of a monthly fee.

While Majestic was innovative in attempting to commercialize the ARG experience, the business model required players to purchase a custom client and pay a recurring subscription fee in order to experience the published narrative. However, ARGs rely on enabling a suspension of disbelief among players to foster immersion in the alternate reality experience. The commercialization of Majestic appears to have had the opposite effect on many participants.

In the fall of the 2002, ABC aired the show, Push, Nevada. Push, Nevada was marketed by Liveplanet as “a dramatic [television] series set in the created town of Push, Nevada.” The show was distributed on ABC and blended elements of fact and fiction, drama and reality that chronicled a strange series of events that involved the Versailles Casino and a missing seven-figure sum of money.

Push, Nevada provided clues relating to the location of the missing money. The intellectual property rights in relation to the narrative (i.e., “game world”) were published simultaneously in a cross-media format (i.e., the online elements were published simultaneously and contemporaneously with weekly broadcasts of an episodic television show). A prize was made available to the “solver” of the riddle to the order of US $1 million as an incentive for players to take part.

Push, Nevada was pitched by a production company (Liveplanet) to a publisher (ABC Television) and as such the implementation itself did not provide or produce an independent revenue stream that allowed further exploitation of the implementation's intellectual property rights. Additionally, the implementation, with clearly published rules and regulations, created too high a barrier of disbelief to create a true immersive alternate reality experience.

In the latter part of 2004, a radio drama entitled, “I Love Bees,” was produced and broadcast by 40rty2wo Entertainment and Bungie Interactive. I Love Bees is described by its creator, 40rty2wo, as “a braided radio drama more than five hours long, written, performed and recorded at the quality level of a major feature film. This story . . . was then broadcast in fragments over more than 1400 payphones, ringing in all fifty states, England, France, Australia, and New Zealand.” Payphones were called from a computerized telephony system that would deliver new audio narrative elements when players uttered the correct response to a posed question. Again, the implementation did not have an independent revenue stream in that the narrative was provided to the players free of charge. Additionally, the separation of the production and broadcast interests largely diminished the value of the intellectual property rights in the narrative elements.

It is possible to categorize the prior art into two discrete categories: commercial implementations and non-commercial implementations. Arguably the two most successful implementations so far have been The Beast and I Love Bees. Both of these implementations have been commercial in that they have been pitched to, or commissioned by, the publisher of a separate work (in the case of The Beast, the Warner Brothers/Dreamworks SKG film “A.I. Artificial Intelligence” and in the case of I Love Bees the Microsoft/Bungie Interactive console video game “Halo 2”). The implementations served in both cases as advertising/marketing vehicles. In both cases, the narrative was made available to the player and players free of charge in an effort of what is now termed viral or word-of-mouth marketing. There was thus no revenue stream available to the producer other than an agreed contract amount for the provision of advertising/marketing services.

What is needed is an ARG architecture that provides both a true alternative reality experience for users and a revenue stream tied to intellectual property rights for the game producers.

### SUMMARY

An embodiment of the present invention provides an alternative reality game (ARG) architecture that utilizes collectibles to generate a revenue stream, provide game rules, distribute narratives, and create interaction by participants. In an embodiment of the present invention, a collectible comprises a unique identifying code and a narrative element. By way of illustration and not as a limitation, the collectible in an exemplary embodiment of the present invention is a trading card. In other embodiments of the present invention, the collectible is a game token, a stuffed animal, a music file, a video file, and combinations of the same. As will be appreciated by those skilled in the art, other collectibles comprising identifying codes can be utilized without departing from the scope of the present invention.

The unique identifying code is obscured such that a player may not determine a status associated with the collectible prior to purchase of that collectible. By way of illustration and not as a limitation, the identifying code may be ascertained by removing a holographic sticker or an opaque coating or foil.

The status of a collectible is relevant to the game narrative. By way of illustration and not as a limitation, the status may be whether the collectible represents a living entity or an android; if a living entity, whether the living entity is currently alive or dead; the powers of the “thing” represented by the collectible; a physical attribute of the thing represented by the collectible; and so on.

Each collectible further comprises a puzzle for the player to solve. In an exemplary embodiment of the present invention, narrative elements directed to solving the puzzle are provided via an Internet site. However, this is not meant as a limitation. Other media may be used to convey narrative elements without departing from the scope of the present invention. By way of illustration, a collectible in the form of a trading card may comprise a narrative element.

In the exemplary embodiment, when the player visits the Internet site, the player is invited to enter the unique identifying code present on the collectible. Upon receipt of the identifying code, the Internet site will consult a database and produce a narrative element that has been associated with the collectible. By way of illustration and not as a limitation, the narrative element is a question requiring a response from the player. The player, upon submission of the correct answer, receives a reward (e.g. points, money, coupons, or access to further narrative elements). Once the player has collected sufficient numbers of collectibles and been exposed to sufficient narrative elements, the player (if sufficiently skilled) is eligible to win a prize.

It is therefore an aspect of the present invention to provide an ARG architecture that utilizes collectibles to generate a revenue stream.

It is another aspect of the present invention to foster a continuing relationship between a game provider and a game player.

It is still another aspect of the present invention to associate an identifying code with a collectible and to associate the identifying code with a narrative element.

It is another aspect of the present invention to require a game player to proffer the identifying code from a collectible to the game provider to the associated narrative element associated with the identifying code.

It is an aspect of the present invention to obscure the code on the collectible so that it may be obtained by a game player only after purchase of the collectible.

It is another aspect of the present invention to associate game rules and objectives with multiple collectibles to produce a continuing revenue stream from game players.

It is yet another aspect of the present invention to utilize tangible objects as collectibles.

It is still another aspect of the present invention to use intangible property as collectibles.

It is still another aspect of the present invention to utilize narrative elements in the form of questions to creative interaction between the game provider and the game player and to reward game players for correct responses.

These and other aspects of the present invention will become apparent from the general and detailed descriptions that follow.

### DESCRIPTION OF THE DRAWINGS

FIG. 1 illustrates a front face of a trading card with a unique identifying code obscured according to an exemplary embodiment of the present invention.

FIG. 2 illustrates a front face of a trading card with a unique identifying code revealed according to an exemplary embodiment of the present invention.

FIG. 3 illustrates a collection of cards forming a puzzle group associated with a common puzzle group identifier according to an exemplary embodiment of the present invention.

FIG. 4 illustrates a distribution of 256 trading cards according to an exemplary embodiment of the present invention.

FIG. 5 illustrates a flow of a process for initiating an ARG by a game provider utilizing trading cards according to an exemplary embodiment of the present invention.

FIG. 6 illustrates a flow of participation in an ARG by a game player utilizing trading cards according to an exemplary embodiment of the present invention.

### DETAILED DESCRIPTION

An embodiment of the present invention provides an ARG architecture that utilizes collectibles to generate a revenue stream, provide game rules, distribute narratives, and create interaction by participants. In an embodiment of the present invention, a collectible comprises a unique identifying code along with narrative elements. The unique identifying code is obscured such that a player may not determine a status associated with the collectible prior to purchase of that collectible. By way of illustration and not as a limitation, the identifying code may be ascertained by removing a holographic sticker or an opaque coating or foil.

The status of a collectible is relevant to the game narrative. By way of illustration and not as a limitation, the status may be whether the collectible represents a living entity or an android; if a living entity, whether the living entity is currently alive or dead; the powers of the “thing” represented by the collectible; a physical attribute of the “thing” represented by the collectible; and so on.

Each collectible further comprises a puzzle for the player to solve. In an exemplary embodiment of the present invention, narrative elements directed to solving the puzzle are provided via an Internet site. However, this is not meant as a limitation. Other media may be used to convey narrative elements without departing from the scope of the present invention. By way of illustration, a collectible in the form of a trading card may comprise a narrative element.

In the exemplary embodiment, when the player visits the Internet site, the player is invited to enter the unique identifying code present on the collectible. Upon receipt of the identifying code, the Internet site will consult a database and produce a narrative element that has been associated with the collectible. By way of illustration and not as a limitation, the narrative element may be a question requiring a response from the player. The player, upon submission of the correct answer, receives a reward (e.g. points, money, coupons, or access to further narrative elements). Once the player has collected sufficient numbers of collectibles and been exposed to sufficient narrative elements, the player (if sufficiently skilled) is eligible to win a prize.

The architecture of the present invention is best illustrated by describing an exemplary embodiment. In the exemplary embodiment described below, the collectibles are trading cards. However, the present invention is not so limited. In other embodiments of the present invention, the collectible is a game token, a stuffed animal, a music file, a video file, and combinations of the same. As will be appreciated by those skilled in the art, other collectibles comprising identifying codes and narrative elements can be utilized without departing from the scope of the present invention.

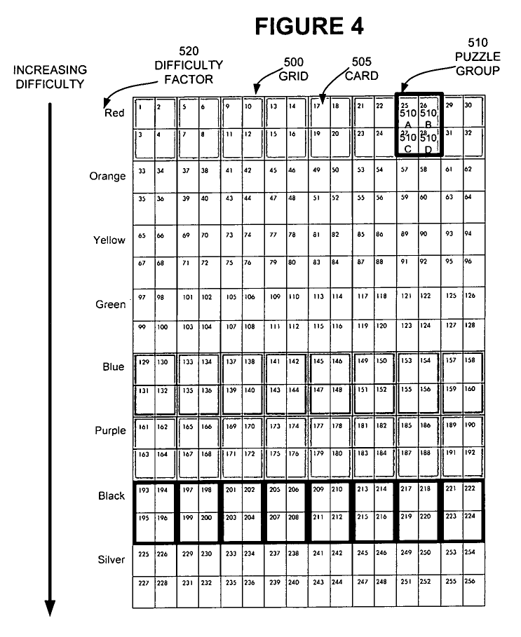

FIG. 4 illustrates a distribution of 256 trading cards according to an exemplary embodiment of the present invention. Referring to FIG. 4, grid 500 represents a set of 256 trading cards 505. The trading cards of grid 500 are arranged in four-card groups (for example, 510A-D) collectively referred to as a puzzle group 510.

Each row of the grid 500 is associated with an increasing “difficulty and rarity” factor 520. The “difficulty and rarity” factor is a measure of how difficult it is for a player to obtain a solution to the puzzle conveyed on the particular card 505 and the number of a particular card that are available for play. As illustrated, the difficulty and rarity increases down the rows, which are labeled by color, from red to silver.

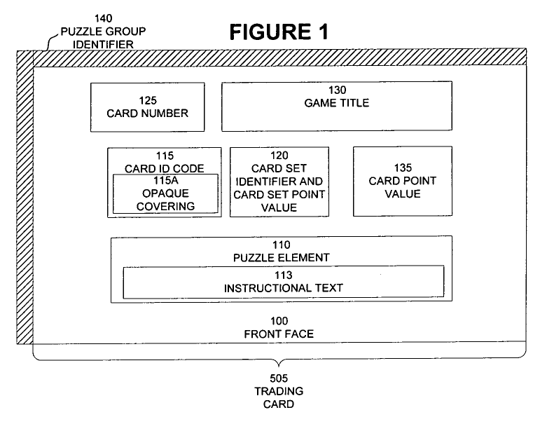

FIG. 1 illustrates a front face of a trading card according to an embodiment of the present invention. The front face 100 of the comprises a puzzle element 110 that may further comprise instructional text 113, a unique card identifying code 115 (illustrated as obscured by opaque covering ISA), an identifier and a card set value 120 relating to the Puzzle Group 510 to which the trading card 505 belongs, a game title 130, a card point value 135, and a puzzle group identifier 140.

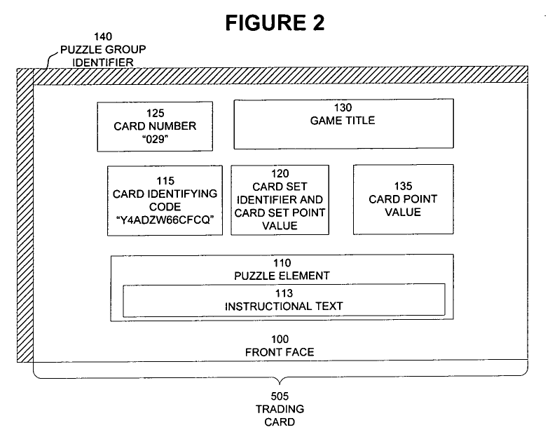

FIG. 2 illustrates a front face of a trading card with a unique card identifying code revealed according to an exemplary embodiment of the present invention. The unique identifying card code 115 is printed on the front face 110 of each trading card 505. This unique code 115 is picked from a pool of millions of such individual codes generated by a randomizing algorithm. The algorithm is constructed in such a method that there is an extremely low probability of being able to “guess” a unique identifying code 115 that has been used on a trading card given the size of the pool from which codes may be picked. This unique identifying code 115, once printed on a card 505, is then obscured by the application of an opaque covering (115A in FIG. 1), which may be scratched off. FIG. 2 further illustrates that number “031” has been assigned to card number 125.

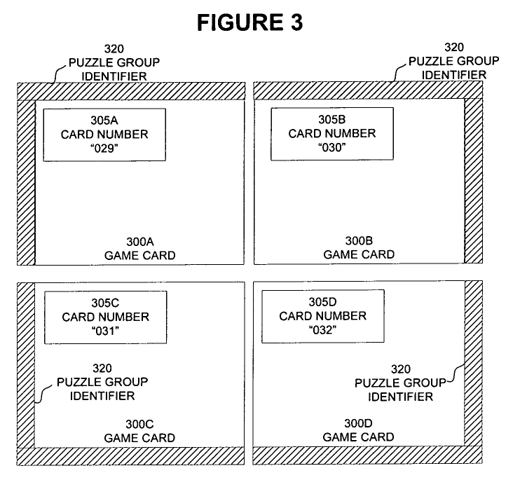

FIG. 3 illustrates four cards that have been assigned to a puzzle group according to an embodiment of the present invention. As illustrated game cards 300 A-D comprise card numbers 305 A-D respectively. Note that other game card elements as illustrated in FIGS. 1 and 2 have been eliminated for clarity. As illustrated in FIG. 3, game cards 300 A-D have been assigned card numbers 029-032 respectively. These cards are identifiable as members of Puzzle Group 510 by the common puzzle group identifier 320 assigned to each card and incorporated into a portion of the trading card border such that when the game cards 300 A-D are placed together edge to edge, the group identifiers align in a logical manner. By way of illustration and not as a limitation, the group identifier 320 is a color. In another embodiment of the present invention, the group identifier 320 comprises a graphical pattern that is unique to Puzzle Group 510.

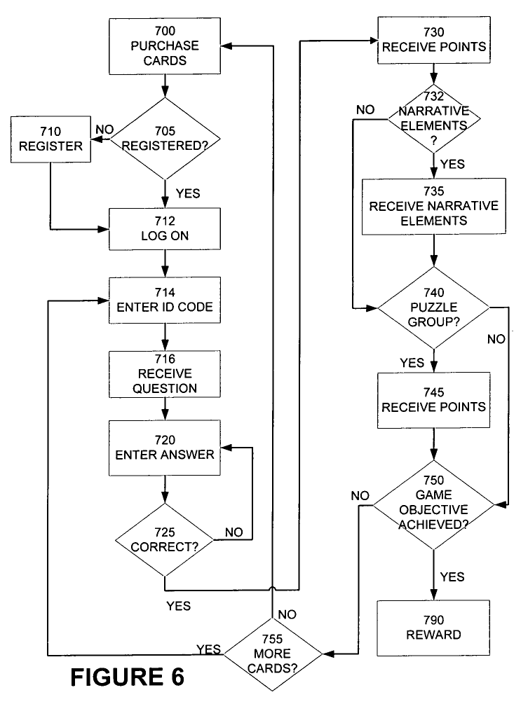

In an embodiment of the present invention, a player of a game interacts with an Internet site operated by a game operator (see FIG. 6 and related discussion provided below). In this embodiment, the Internet site is able to ascertain if a proffered solution of a game card will result in the completion of all puzzles in a Puzzle Group 510. If the player successfully solves all the puzzles in a particular Puzzle Group 510, points are credited to the player's account on the Internet site. In another embodiment of the present invention, a number of “bonus” points may be credited depending on whether the player is the first, tenth, hundredth, etc. to solve all puzzles in that particular group.

Referring again to FIG. 3 and to FIG. 4, in another embodiment of the present invention, the puzzle group identifier 320 is color coded to indicate a difficulty and rarity factor associated with a Puzzle Group 510. In this embodiment, the puzzle group identifier 320 uses a color that is selected according to the difficulty and rarity factor 520 associated with the Puzzle Group 510.

In the exemplary embodiment of the present invention, a game comprises an objective and rules whereby a player may achieve that objective. A player achieving the objective receives a reward. For illustrative purposes and not as a limitation, the objective of the game of the exemplary embodiment is the recovery of a stolen artifact. As will be appreciated by those skilled in the art, other objectives may be established for a game without departing from the scope of the present invention. By way of illustration and not as a limitation, the game objective may be world domination, defending the motherland, finding treasure, or winning a race.

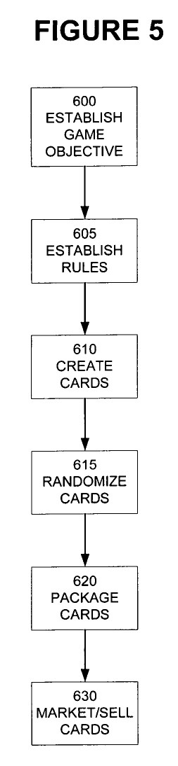

FIG. 5 illustrates a flow of a process for initiating an ARG by a game provider utilizing trading cards according to an exemplary embodiment of the present invention. A game provider establishes a game objective 600 and the rules whereby that objective may be achieved by a game player 605. In the exemplary embodiment, the rules establish that 256 cards (505) will be issued. The players are told that the information required to recover the artifact is dispersed among the 256 individual cards 505, but that not all 256 cards 505 are required in order to ascertain the artifact's location. Upon recovery of the artifact, the successful player (or group of players) is entitled to claim a monetary prize from the game providers.

Individual cards are created 610 and randomized 615. The randomized cards are packaged 620 for sale. These card packs are then marketed and sold to players 630 with instructions that each card bears a puzzle, the solving of which will make available additional narrative elements to that player. The availability of those narrative elements may or may not assist in the providing further information as to the recovery of the stolen artifact.

FIG. 6 illustrates a flow of participation in an ARG by a game player utilizing trading cards according to an exemplary embodiment of the present invention. A player purchases a card pack 700. In the exemplary embodiment of the present invention, a player interacts with an Internet site operated by the game operator. A determination is made whether the player is registered with the game provider 705. If the player is registered with the game provider 705, the player logs on to the game operator's server 712. If the player is not registered with the game provider 705, the player first registers with the server 710 and then logs on to the server 712.

The player enters the unique identifying code from a card which the player wishes to solve 714. The Internet site then consults a database comprising all of the unique identifying codes, ascertains which card of the 256 cards the unique identifying code pertains to and presents to the player the puzzle posed on the trading card, together with a prompt for the answer 716.

The player then enters an answer 720. A determination is made whether the answer proffered by the play is the correct answer 725. If the answer proffered by the play is not the correct answer 725, the player is prompted for the answer 716. If the answer proffered by the play is the correct answer 725, the player is credited with a number of points 730. In an embodiment of the present invention, the number of points received by the player is determined by a point system that reflects how many other players had provided the correct answer. The point system thereby provides greater reward, and therefore greater incentive, to be an earlier solver of the puzzle.

In another embodiment of the present invention, the points awarded to a player are credited to a player's account on the computer system and reflected in a publicly posted “leaderboard” whereby players may ascertain their relative position in completing and solving positions against other competing players.

A determination is made whether the correct solution entitles the player to additional narrative elements 732. The additional narrative elements may be provided over a specified media. By way of illustration and not as limitation, the additional narrative elements may be provide via email, a telephone call, a physical letter, or via the game provider's Internet site.

If the correct solution entitles the player to additional narrative elements, the player receives the addition narrative elements 734 and the process continues at 740. If the correct solution does not entitle the player to additional narrative elements, the process continues at 740.

A determination is made whether the player has completed the puzzles of all cards belonging to a particular puzzle group 740. If the player has completed the puzzles of a puzzle group, the player receives additional points 745. Players are thus incentivized to collect a set of cards comprising a Puzzle Group. In an embodiment of the present invention, a Puzzle Group is identified by four trading cards being placed together to form edge to edge so that the graphical identifier relating to the Puzzle Group and the graphical identifier relating to relative rarity are aligned in a logical manner (see FIG. 3). The game provider's server determines from the unique identifying code submitted, which of the 256 cards the particular unique identifying code relates to and which Puzzle Group the trading card belongs to. The server also determines whether the solving of a particular puzzle will result in the completion of all puzzles in a Puzzle Group. If the player successfully solves all the puzzles in a particular Puzzle Group, again, points are credited to the player's account in accordance with a point system.

A determination is made whether the player has achieved the game objective 750. If the player has achieved the game objective, the game is over and the player receives a reward 790. If the player has achieved the game objective, the game continues at 755 where it is determined whether the player has more cards to play. If the player has more cards to play, the player enters a card ID code 714. If the player has no more cards to play, the game is suspended until the player purchases more cards 700.

In another embodiment of the present invention, players are incentivized to provide further contact information to the computer system when players login to the game provider's server. The server displays a message to the player if there is no record of any mailing address or telephone number for the player stating that if the player were to provide such information to the computer system, then the player may receive further narrative elements.

An ARG architecture has been described. It will be apparent to those skilled in the art that the business method and game play mechanic of the present invention may be modified in numerous ways and may assume many embodiments other than those specifically set out and described above without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

We claim:

1. A method for generating a revenue stream from a game comprising:
defining a game objective and a narrative;
defining a set of collectible game pieces, wherein a collectible game piece comprises a unique identifier and a narrative element, and wherein the narrative element of at least some of the collectible game pieces relates to the narrative;
assigning a puzzle and a puzzle solution to the collectible game piece and associating the puzzle and the puzzle solution with the unique identifier, wherein the puzzle solution of at least some of the collectible game pieces relates to achievement of the game objective;
providing means for a game player to acquire a random assortment of collectible game pieces in exchange for payment;
providing means for the game player to proffer the unique identifier and a proffered puzzle solution;
awarding points to the player if the proffered solution is the puzzle solution; and
incentivizing offering a prize to a winning player achieving the game objective and having the most points.

2. The method for generating a revenue stream from a game of claim 1, wherein the collectible game piece is selected from the group consisting of a card, a toy, an audio recording, a video recording, a photograph, a digital file, a digital storage device, an analog storage device, and a holographic image.

3. The method for generating a revenue stream from a game of claim 1, wherein the game objective is selected from the group consisting of recovering a stolen object, world domination, saving a hostage, capturing a criminal, defending the motherland, finding treasure, and winning a race.

4. The method for generating a revenue stream from a game of claim 1, wherein the method further comprises awarding an additional narrative element to the player if the proffered solution is the puzzle solution.

5. A method for playing a game comprising:
defining a game objective and a narrative; defining a set of collectible game pieces, wherein a collectible game piece comprises a unique identifier and a narrative element, and wherein the narrative element of at least some of the collectible game pieces relates to the narrative;
assigning a puzzle and a puzzle solution to the collectible game piece and associating the puzzle and the puzzle solution with the unique identifier, wherein the puzzle solution of at least some of the collectible game pieces relates to achievement of the game objective;
providing means for a game player to acquire a random assortment of collectible game pieces in exchange for payment;
providing means for the game player to proffer the unique identifier and a proffered puzzle solution;
awarding points to the player if the proffered solution is the puzzle solution; and
incentivizing the player by offering a prize to a winning player achieving the game objective and having the most points.

6. The method for playing a game of claim 5, wherein the collectible game piece is selected from the group consisting of a card, a toy, an audio recording, a video recording, a photograph, a digital file, a digital storage device, an analog storage device, and a holographic image.

7. The method for playing a game of claim 5, wherein the game objective is selected from the group consisting of recovering a stolen object, world domination, saving a hostage, capturing a criminal, defending the motherland, finding treasure, and winning a race.

8. The method for playing a game of claim 5, wherein the method further comprises awarding an additional narrative element to the player if the proffered solution is the puzzle solution.
